(19) United States
(12) Patent Application Publication
(10) Pub. No.: US 2007/0064566 A1
(43) Pub. Date: Mar. 22, 2007

(54) Signal process device and method for obtaining wobble signal

(76) Inventors: Wei-Hsin Hsu, Sijhih City (TW); Yu-Kai Chou, Kaohsiung City (TW)

Correspondence Address: THE LAW OFFICES OF ANDREW D. FORTNEY, PH.D., P.C., 401 W FALLBROOK AVE STE 204, FRESNO, CA, 93711-5835, US

(21) Appl. No.: 11/525,252

(22) Filed: Sep. 20, 2006

(30) Foreign Application Priority Data
Sep. 21, 2005 (TW) 094232590

(51) Int. Cl. G11B 27/36; G11B 7/00

(52) U.S. Cl. 369/53.34; 369/44.13

(57) ABSTRACT

A signal process device and method is provided to obtain a wobble signal from a set of retrieved signals. The signal process device comprises: an RF amplifier, band-pass filter, and a feedback control module. The RF amplifier generates a mix signal by synthesizing the set of retrieved signals reflected from an optical information recordable medium. The band-pass filter generates a transient-state wobble signal by performing band-pass filtering on the mix signal based on a target frequency. The feedback control module provides that target frequency by receiving the transient-state wobble signal and performing phase-locked loop and frequency dividing operations thereon. The feature and characteristic of the invention resides especially on repeatedly amending the target frequency via the feedback control module. In this setting, the band-pass filter is able to perform band-pass filtering on the mix signal based on the amended target frequency and obtain the desired wobbly signal.

### BACKGROUND OF THE INVENTION

1. Field of the Invention

The present invention relates to a signal process device and method utilized by an optical information recording/producing apparatus. More particularly, the present invention utilizes a feedback control module and a band-pass filter to obtain a wobble signal retrieved from an optical information recordable medium by the optical information recording/producing apparatus.

2. Description of the Prior Art

Most optical information recording/producing apparatuses adopt the constant linear velocity (CLV) operation mode in reading or recording optical data on the optical information recordable medium (e.g., CD-R, CD-RW, DVD-R, DVD-RW, etc.). The recording/producing apparatus utilizes a wobble signal from a set of retrieved signals to control the optical pick-up head. Because the central frequency of the wobble signal in the retrieved signals is constant, it is rather simple to obtain the wobble signal from the retrieved signals.

Under the CLV mode, it is also easy for the recording/producing apparatus to control the optical pick-up head. However, when the optical pick-up head moves from the inner zone of the optical information recordable medium, for example a CD-R, to its outer zone, or vice versa, instability sometimes occurs due to the different circumstantial lengths of the inner and outer zone. This will cause errors in reading or recording the optical data. In order to reduce the instability, another operation mode, constant angular velocity (CAV), is adopted in the recording/producing apparatus. Under the CAV mode, the central frequency of the wobble signal in the retrieved signals is variable with the location of the pick-up head on the CD-R medium. It is not easy to obtain the wobble signal from the retrieved signals to control the optical pick-up head. There is no satisfactory solution in prior art so far.

Besides, when there is unknown instability situation or the user intends to change the reading speed in the recording/producing apparatus, the central frequency of the wobble signal in the retrieved signals also varies.

### SUMMARY OF THE INVENTION

An objective of the present invention is to provide a signal process device and method. By utilizing a feedback control module and a band-pass filter, the wobble signal can be obtained from the retrieved signals reflected from the optical information recordable medium. More particularly, the signal process device and method of the present invention provide superior solution in the situation where the central frequency of the wobble signal is variable.

According to a preferred embodiment of the present invention, the signal process device comprises: an RF amplifier, a band-pass filter, and a feedback control module. The RF amplifier generates a mix signal by synthesizing the set of retrieved signals reflected from an optical information recordable medium. The band-pass filter generates a transient-state wobble signal by performing band-pass filtering on the mix signal based on a target frequency. The feedback control module provides the target frequency by receiving the transient-state wobble signal and performing phase-locked loop and frequency dividing functions thereon. The feature and characteristic of the invention resides especially on repeatedly amending the target frequency via the feedback control module. In this setting, the band-pass filter is able to perform band-pass filtering on the mix signal based on the amended target frequencies and ultimately obtain the desired wobbly signal.

According to another preferred embodiment of the present invention, the signal process device comprises: an automatic gain controller (AGC), a comparator, a phase-locked loop device, and a frequency divider. The phase-locked loop device receives a digital signal from the comparator and performs phase-locked loop function to generate a first reference clock. The frequency divider receives the first reference clock from the phase-locked loop device and performs frequency division function, so as to obtain the target frequency for the band-pass filter. This would ultimately help to obtain the desired wobble signal from the retrieved signals.

According to another preferred embodiment of the present invention, a signal process method is provided for obtaining a wobble signal from a set of retrieved signals. The method mainly comprises the following steps: (1) retrieving the set of retrieved signals reflected from an optical information recordable medium and synthesizing into a mix signal; (2) performing band-pass filtering on the mix signal based on a target frequency and obtaining a transient-state wobble signal; (3) performing phase-locked loop and frequency dividing functions on the transient-state wobble signal in a feedback control module for obtaining the target frequency; and (4) repeatedly amending the target frequency in the feedback control module so as to perform band-pass filtering on the mix signal based on the amended target frequency, and obtaining the desired wobbly signal.

According to another preferred embodiment of the present invention, the signal process method obtains the desired target frequency in the following steps: (3a) automatically adjusting a gain of the transient-state wobble signal obtained in step (2) and generating an analog signal with substantially the same peak-to-peak value; (3b) comparing the analog signal with a reference signal to generate a digital signal; (3c) performing phase-locked loop function on the digital signal to generate a first reference clock; and (3d) performing frequency division function on the first reference clock, so as to obtain the desired target frequency.

The advantage and spirit of the invention may be understood by the following recitations together with the appended drawings.

### BRIEF DESCRIPTION OF THE APPENDED DRAWINGS

FIG. 1 is a schematic diagram showing the optical information recording/producing apparatus and the optical information recordable medium according to the present invention.

FIG. 2 is a functional block diagram of a signal process device according to a preferred embodiment of the present invention.

FIG. 3 is a schematic diagram showing the four divided areas of the optical pick-up head of the present invention.

FIG. 4 is a schematic diagram showing how the RF amplifier synthesizes the retrieved signals to obtain the mix signal according to the present invention.

FIG. 5 is a waveform diagram generated by the RF amplifier from a blank medium under the CLV mode according to the present invention.

FIG. 6 is a waveform diagram generated by the RF amplifier from a data medium under the CLV mode according to the present invention.

FIG. 7 is a spectrum distribution diagram of the wobble signal and high frequency RF signal from the first signal A and the fourth signal D according to the present invention.

FIG. 8 is a spectrum distribution diagram of the wobble signal and high frequency RF signal from the second signal B and the third signal C according to the present invention.

FIG. 9 is a spectrum distribution diagram of the signal after the band-pass filter according to the present invention.

FIG. 10 is a waveform diagram of the output analog signal Vp-p from the AGC according to the present invention.

FIG. 11 is a waveform diagram of the output digital signal from the comparator according to the present invention.

FIG. 12(A) and FIG. 12(B) are flowcharts showing the signal process method according to another embodiment of the present invention.

### DETAILED DESCRIPTION OF THE INVENTION

The present invention provides a signal process device and method. By repeatedly amending a target frequency in a feedback control module, a band-pass filter of the present invention is able to perform band-pass filtering on a mix signal based on the amended target frequencies and further obtain the wobbly signal from a set of retrieved signals reflected from an optical information recordable medium.

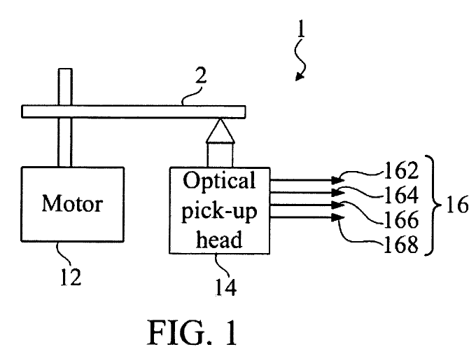

Refer to FIG. 1 for the set of retrieved signals. FIG. 1 is a schematic diagram showing the optical information recording/ producing apparatus 1 and the optical information recordable medium 2 according to the present invention. As shown in FIG. 1, the optical information recordable medium 2 is rotated by a motor 12 and an optical pick-up head 14 is utilized to retrieve signals from the medium 2. A set of retrieved signals 16 are outputted, which comprises a first signal 162, a second signal 164, a third signal 166 and a fourth signal 168. Here, the optical information recording/producing apparatus 1 according to the present invention can be any apparatus capable of recording, reading, or playing optical information/data, for example, all kinds of CD-R, CD-RW, DVD-R, DVD-RW drives. The optical information recordable medium 2 according to the present invention can be any optical medium capable of recording, reading, or playing optical information/data, for example, all kinds of CD-R, CD-RW, DVD-R, DVD-RW disks.

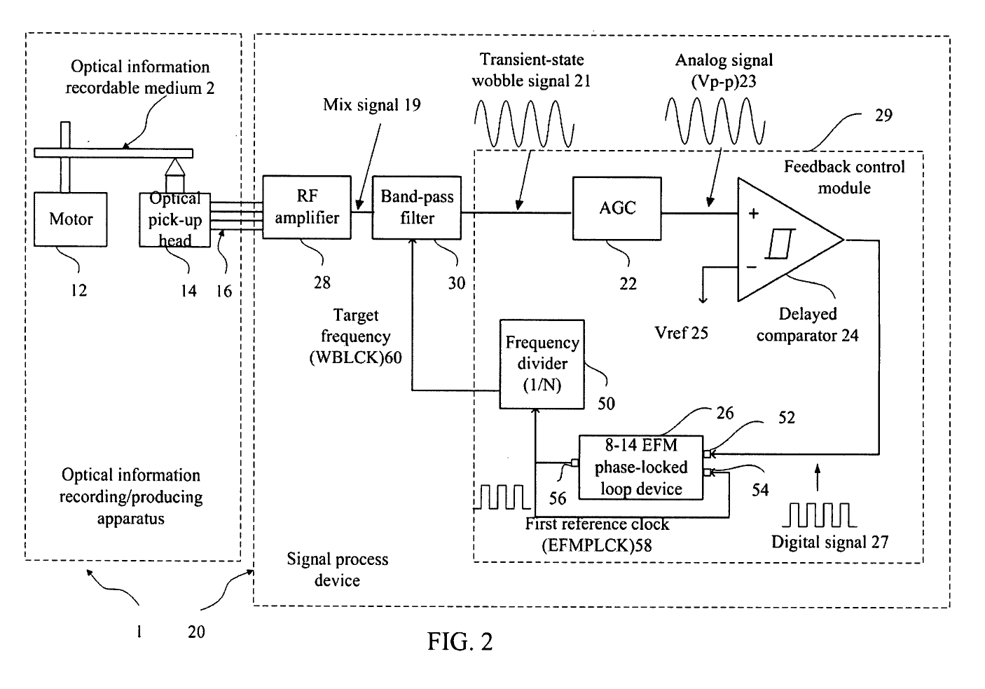

Referring to FIG. 2, FIG. 2 is a functional block diagram of a signal process device 20 according to a preferred embodiment of the present invention. As shown in FIG. 2, the signal process device 20 mainly comprises: a radio frequency (RF) amplifier 28, a band-pass filter (BPF) 30 and a feedback control module 29. The RF amplifier 28 generates a mix signal 19 by synthesizing the set of retrieved signals 16 extracted from the optical pick-up head 14. The band-pass filter 30 (with central frequency in n*22.05 kHz in this embodiment) generates a transient-state wobble signal 21 by performing band-pass filtering on the mix signal based on a target frequency (WBLCK) 60. The feedback control module 29 obtains the target frequency 60 by receiving the transient-state wobble signal 21 and performing phase-locked loop and frequency dividing operations on the transient-state wobble signal 21. By repeatedly amending the target frequency 60 in the feedback control module 29, the band-pass filter 30 is enabled to perform band-pass filtering repeatedly on the mix signal 19 based on the amended target frequency. Therefore, even the central frequency of the wobble signal is variable under the CAV mode, the present invention can use the amended target frequency as the required central frequency for the band-pass filter 30. Thus, even under the CAV mode, the wobble signal can be accurately obtained from the retrieved signals.

Referring to FIG. 3 and FIG. 4, FIG. 3 is a schematic diagram showing the four divided areas of the optical pick-up head 14 of the present invention. FIG. 4 is a schematic diagram showing how the RF amplifier 28 synthesizes the retrieved signals 16 to obtain the mix signal 19 according to the present invention. The optical pick-up head 14 of the present invention can be conceptually divided into four areas: a left-up area, a right-up area, right-down area, and a left-down area for reading the reflected RF signals from the optical information recordable medium 2, and a set retrieved signals 16 is rendered. The set of retrieved signals 16 comprises: a first signal (A) retrieved from the left-up area of the optical pick-up head 14; a second signal (B) retrieved from the right-up area of the optical pick-up head 14; a third signal (C) retrieved from the right-down area of the optical pick-up head 14; and a fourth signal (D) retrieved from the left-down area of the optical pick-up head 14. The RF amplifier 28 synthesizes the retrieved signals 16 to obtain the mix signal 19 according to the following formulae in one embodiment:
the mix signal=(the first signal+the fourth signal)−(the second signal+the third signal).

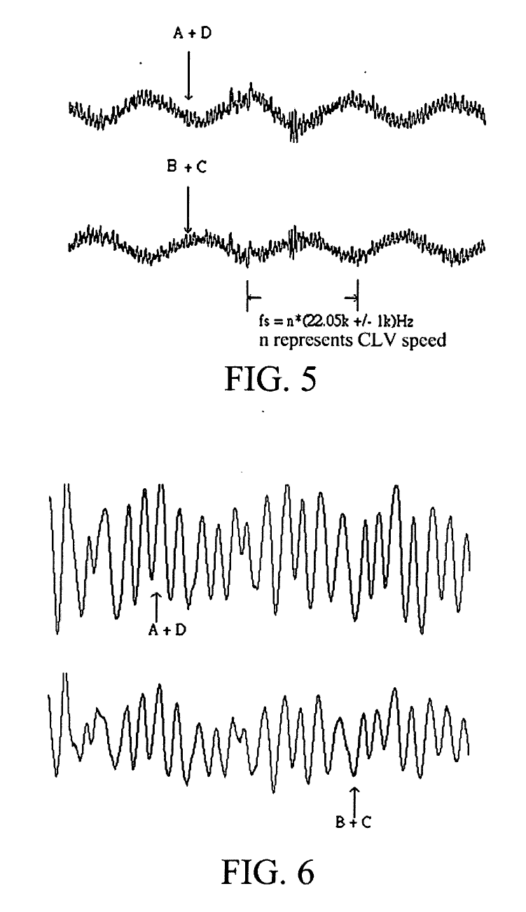

Referring to FIG. 5 and FIG. 6, FIG. 5 is a waveform diagram generated by the RF amplifier from a blank medium under the CLV mode according to the present invention. FIG. 6 is a waveform diagram generated by the RF amplifier from a data medium under the CLV mode according to the present invention. FIG. 5 and FIG. 6 can be accompanied by FIG. 3 and FIG. 4 for better understanding. Taking CD-R/RW disk as an example, the ATIP (Absolute Time In Pre-groove) uses wobble signal as a carrier. The FSK modulation is further utilized to obtain the relative position of the optical pick-up head 14 to the CD-R/RW disk 2 where the frequency of the wobble signal is n*(22.05 k+/−1 k) Hz, with n representing the CLV speed (for example 1 X˜52 X). FIG. 5 shows a waveform generated by the RF amplifier reading from an unrecorded blank disk under the CLV mode. Because this is a blank disk, the signal waveform shown in FIG. 5 is essentially the wobble signal. FIG. 6 shows a waveform generated by the RF amplifier reading from a data medium under the CLV mode. As shown in the figure, when data is recorded in the disk 2, the wobble signal would be included in the retrieved RF signals 16. That is, they are not pure wobble signal any more, but rather mixed with high frequency RF signals.

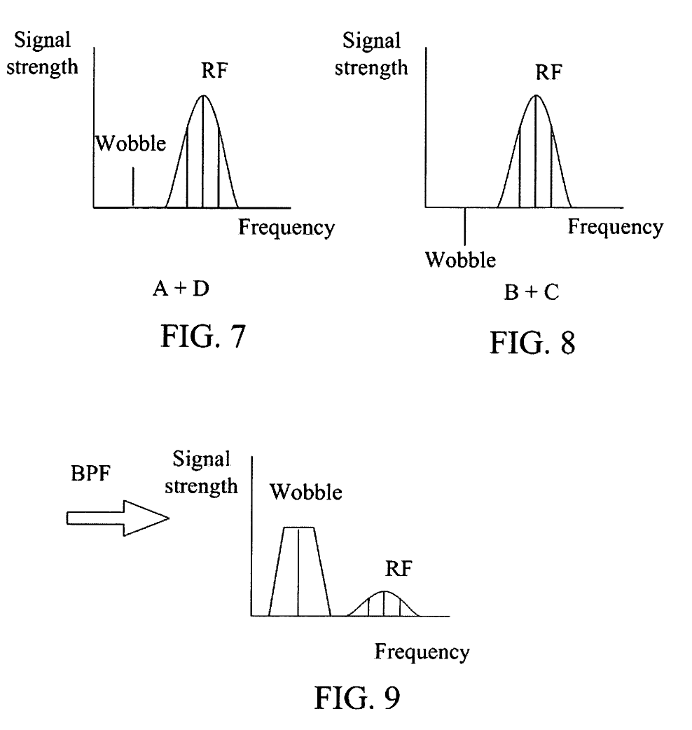

Refer to FIGS. 7-9 accompanying FIG. 4 for better understanding. FIG. 7 is a spectrum distribution diagram of the wobble signal and high frequency RF signal from the first signal A and the fourth signal D according to the present invention. FIG. 8 is a spectrum distribution diagram of the wobble signal and high frequency RF signal from the second signal B and the third signal C according to the present invention. FIG. 9 is a spectrum distribution diagram of the signal after the band-pass filter according to the present invention. As shown in FIG. 4, the RF amplifier 28 first adds the first signal A from the left-up area of the optical pick-up head 14 and the fourth signal D from the left-down area. The spectrum distribution of the signal A+D is clearly shown in FIG. 7. The wobble signal belongs to the signal of lower frequencies, and the RF signal belongs to the signal of higher frequencies. Similarly, the RF amplifier 28 further adds the second signal B from the right-up area of the optical pick-up head 14 and the third signal C from the right-down area. The spectrum distribution of the signal B+D is clearly shown in FIG. 8. The wobble signal belongs to the signal of lower frequencies, and the RF signal belongs to the signal of higher frequencies.

After the RF amplifier 28 obtains the mix signal 19 according to the following formulae: the mix signal=(the first signal+the fourth signal)−(the second signal+the third signal), the mix signal 19 is further processed by the band-pass filter 30. The spectrum distribution of the signal generated by the band-pass filter 30 is clearly shown in FIG. 9. That is, the signal strength of the wobble signal is enhanced. The RF signal would be greatly reduced because of the cancellation effect of the (A+D)−(B+C) signal and the frequency filtering effect of the band-pass filter 30.

Take CD-R/RW disk as an example. The present invention utilizes the BPF 30 to extract the needed ATIP. Though under the CLV mode, the central frequency of the BPF 30 can be constant value, under the CAV mode, the central frequency of the BPF 30 must be varied. One objective of the present invention is to control the central frequency of the BPF 30 by a first reference clock (EFMPLCK) 58 in a feedback manner. This would enable a more precise separation of the desired wobble signal to better serve the objective of the present invention. The details would be clearly described in the following.

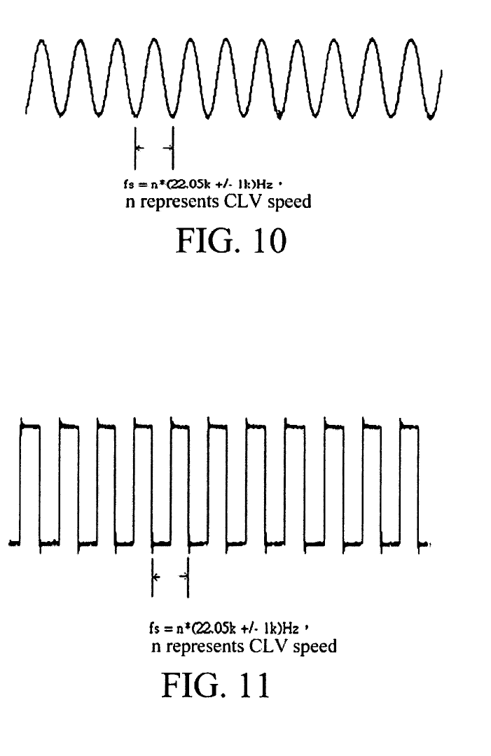

Referring to FIG. 2 and FIG. 10, FIG. 10 is a waveform diagram of the output analog signal Vp-p from the AGC according to the present invention. Another embodiment of the present invention is disclosed to better serve the objective of a more precise obtaining of the desired wobble signal. The feedback control module 29 in the signal process device 20 according to the present invention comprises an automatic gain controller (AGC) 22, a comparator 24, a phase-locked loop device 26 and a frequency divider 50. The AGC 22 receives the transient-state wobble signal 21, automatically adjusts a gain of the transient-state wobble signal 21 and accordingly generates an analog signal (Vp-p) 23 with substantially the same peak-to-peak value. Because different optical information recordable mediums 2 read by the optical information recording/producing apparatus 1 can have substantial differences, one purpose of the AGC 22 is to avoid huge differences in the amplitudes of the transient-state wobble signals 21 from different mediums 2, which can substantially affect the normal operations of the comparator 24 and the phase-locked loop device 26. Therefore, after the AGC 22 receives the transient-state wobble signal 21, the gain is automatically adjusted so as to keep substantially the same peak-to-peak value as the other transient-state wobble signal from different mediums 2. This would help the signal process device 20 to function stably. The waveform of the analog signal Vp-p 23 is shown in FIG. 10.

Referring to FIG. 2 and FIG. 11, FIG. 11 is a waveform diagram of the output digital signal from the comparator according to the present invention. The comparator 24 compares the analog signal (Vp-p) 23 from the AGC 22 with a reference signal (Vref) 25, and generates a digital signal 27. In a preferred embodiment, the comparator 24 is a delayed comparator to delay the analog signal (Vp-p) 23 of the AGC 22 for a period of time. This can minimize the noise interference to enable a better signal quality and a better signal process result. The delayed analog signal (Vp-p) 23 is compared with the reference signal (Vref) 25 so as to transform the analog signal (Vp-p) 23 to the digital signal 27. In a preferred embodiment, the reference signal (Vref) 25 is obtained from the DC level of the retrieved signals by the RF amplifier 28. This would also help the signal process device 20 to function stably, and enable a better signal quality and a better signal process result.

The phase-locked loop device 26 receives the digital signal 27 from the comparator 24, performs the phase-locked loop function and generates a first reference clock (EFMPLCK) 58. The phase-locked loop device 26 comprises a first input terminal 52, a second input terminal 54 and an output terminal 56. The first input terminal 52 receives the digital signal 27 generated from the comparator 24. Afterwards, the phase-locked loop function is performed on the digital signal 27 within the phase-locked loop device 26. The result, i.e., the first reference clock (EFMPLCK) 58, is outputted via the output terminal 56 to the frequency divider 50. The first reference clock (EFMPLCK) 58 is also fed back to the second input terminal 54, and becomes another input signal in performing the phase-locked loop function. In a preferred embodiment, the phase-locked loop device 26 is an Eight-to-Fourteen Modulation (EFM) phase-locked loop device for performing phase-locked loop function. The EFM phase-locked loop device is commonly accommodated in this art, and inside operation and function are not repeated here.

Finally, the frequency divider 50 receives the first reference clock (EFMPLCK) 58 from the phase-locked loop device 26 and performs necessary frequency division function. This would effectively make the signal frequency lower, so as to obtain the target frequency 60 for the next band-pass filtering operation. This iteration continues until the signal becomes stable. The timing of stability can be observed from the changes of the transient-state wobble signal 21. When the transient-state wobble signal 21 becomes stable, it means the phase-locked loop device 26 has successfully locked the phase of the signal, and a stable target frequency 60 has been obtained. Then, the output of the BPF 30 is the wobble signal that the present invention tries to obtain.

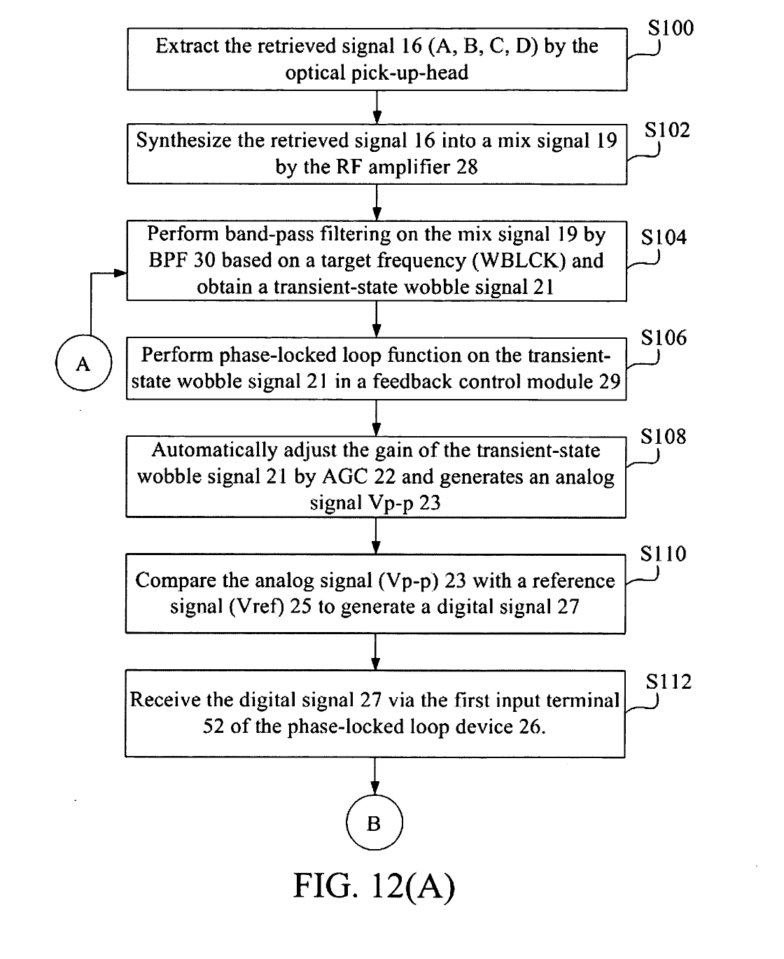

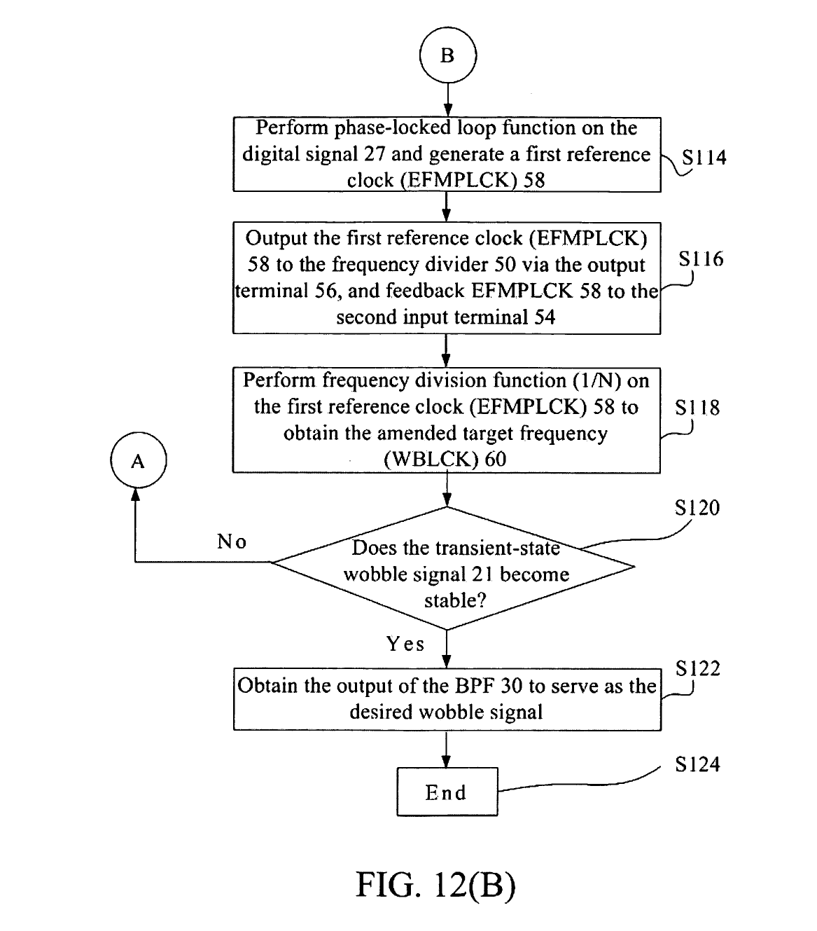

Referring to FIG. 12(A) and FIG. 12(B), FIG. 12(A) and FIG. 12(B) are flowcharts showing the signal process method according to another embodiment of the present invention. The present invention provides a signal process method for obtaining a wobble signal from a set of retrieved signals. The method mainly comprises the following steps: (1) retrieving the set of retrieved signals reflected from an optical information recordable medium and synthesizing into a mix signal; (2) performing band-pass filtering on the mix signal based on a target frequency and obtaining a transient-state wobble signal; (3) performing phase-locked loop and frequency dividing functions on the transient-state wobble signal in a feedback control module for obtaining the target frequency; and (4) repeatedly amending the target frequency in the feedback control module so as to perform band-pass filtering on the mix signal based on the amended target frequency, and ultimately obtaining the desired wobbly signal from the retrieved signals.

In the step (3) above, the desired target frequency can be obtained in the following sub-steps: (3a) automatically adjusting a gain of the transient-state wobble signal obtained in step (2) and generating an analog signal with substantially the same peak-to-peak value; (3b) comparing the analog signal with a reference signal to generate a digital signal; (3c) performing phase-locked loop function on the digital signal to generate a first reference clock; and (3d) performing frequency division function on the first reference clock, so as to obtain the desired target frequency.

The signal process method above can be explained in detailed steps in reference to the flowcharts in FIG. 12(A) and FIG. 12(B).

Step 100: Extract the retrieved signal 16 (A, B, C, D) by the optical pick-up-head. Go to Step 102.

Step 102: Synthesize the retrieved signal 16 into a mix signal 19 by the RF amplifier 28. Go to Step 104.

Step 104: Perform band-pass filtering on the mix signal 19 by BPF 30 based on a target frequency (WBLCK) and obtain a transient-state wobble signal 21. Go to Step 106.

Step 106: Perform phase-locked loop function on the transient-state wobble signal 21 in a feedback control module 29. Go to Step 108.

Step 108: Automatically adjust the gain of the transient-state wobble signal 21 by AGC 22 and generates an analog signal Vp-p 23. Go to Step 110.

Step 110: Compare the analog signal (Vp-p) 23 with a reference signal (Vref) 25 to generate a digital signal 27. Go to Step 112.

Step 112: Receive the digital signal 27 via the first input terminal 52 of the phase-locked loop device 26. Go to Step 114.

Step 114: Perform phase-locked loop function on the digital signal 27 and generate a first reference clock (EFMPLCK) 58. Go to Step 116.

Step 116: Output the first reference clock (EFMPLCK) 58 to the frequency divider 50 via the output terminal 56, and feedback EFMPLCK 58 to the second input terminal 54. Go to Step 118.

Step 118: Perform frequency division function (1/N) on the first reference clock (EFMPLCK) 58 to obtain the amended target frequency (WBLCK) 60. Go to Step 120.

Step 120: Does the transient-state wobble signal 21 become stable? No, go to Step 104. Yes, go to Step 122

Step 122: Obtain the output of the BPF 30 to serve as the desired wobble signal. Go to Step 124.

Step 124: End.

The features and benefits of the signal process device and method according to the present invention can be summarized, but not limited to, in the following. (1) The present invention obtains the wobble signal on the recorded medium by utilizing the band-pass filter on the mix signal generated from the RF amplifier. Here, the central frequency of the band-pass filter is adjustable. This is especially beneficial for the optical drivers operated under the CAV mode. (2) The present invention proposes a novel means as to the central frequency adjustment of the band-pass filter. A target frequency is obtained via a feedback control module together with the phase-locked loop and necessary frequency division operations. It then serves as the central frequency required by the filtering function of the band-pass filter. (3) The present invention provides the feedback control module to repeatedly amend the obtained target frequency, based on which the mix signal is band-pass filtered. Therefore, the target frequency can be finely tuned. The band-pass filter can output the desired wobble signal in a more precise manner by filtering most of the unwanted high frequency RF signals. This would obtain the desired wobble signal from the retrieved signals in a more effective and precise manner. The obtained wobble signal therefore possesses higher quality and higher S/N ratio than the prior-art. (4) The AGC is utilized to avoid wide range of amplitude differences from the transient-state wobble signals in different optical information recordable mediums. The amplitudes of the transient-state wobble signals in different recordable mediums are thus kept substantially the same peak-to-peak values. This would assure and enhance the normal and stable operations of the comparator and the phase-locked loop device. This also greatly contributes to the accuracy of the target frequency. (5) The delayed comparator is utilized to delay the analog signal of the AGC for a period of time. This can minimize the noise interference, and also greatly contribute to the accuracy of the target frequency. (6) The reference signal used in the delayed comparator is obtained from the DC level of the retrieved signals. This would also help the stable operation of the signal process device 20, so that the signal quality is maintained in different circuit stages.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A signal process device for obtaining a wobble signal from a set of retrieved signals, comprising:
an RF amplifier for generating a mix signal by synthesizing the set of retrieved signals reflected from an optical information recordable medium;
a band-pass filter for generates a transient-state wobble signal by performing band-pass filtering on the mix signal based on a target frequency; and
a feedback control module for obtaining the target frequency by receiving the transient-state wobble signal and performing phase-locked loop and frequency dividing operations on the transient-state wobble signal;
wherein by repeatedly amending the target frequency in the feedback control module, the band-pass filter is enabled to perform band-pass filtering on the mix signal based on the amended target frequency and the desired wobbly signal is obtained.

2. The device of claim 1, wherein the feedback control module comprises:
an automatic gain controller (AGC) for receiving the transient-state wobble signal and automatically adjusting a gain of the transient-state wobble signal and generating an analog signal with substantially the same peak-to-peak value;
a comparator for comparing the analog signal from the AGC with a reference signal and generating a digital signal;
a phase-locked loop device for receiving the digital signal from the comparator, performing phase-locked loop function and generating a first reference clock; and
a frequency divider for receiving the first reference clock from the phase-locked loop device and performing frequency division function, so as to obtain the target frequency for the band-pass filter.

3. The device of claim 2, wherein the AGC receives the transient-state wobble signal and automatically adjusts the gain to avoid wide range of amplitude differences from the transient-state wobble signals in different optical information recordable mediums, so that the amplitudes of the transient-state wobble signals in different optical information recordable medium are kept substantially the same peak-to-peak values.

4. The device of claim 2, wherein the comparator is a delayed comparator to delay the analog signal of the AGC for a period of time for minimizing the noise interference, and transforms the analog signal to the digital signal after comparison with the reference signal, which is obtained from the DC level of the set of retrieved signals reflected from the RF amplifier.

5. The device of claim 2, wherein the phase-locked loop device is an Eight-to-Fourteen Modulation (EFM) phase-locked loop device for performing phase-locked loop function, and comprises a first input terminal, a second input terminal and an output terminal, and wherein the first input terminal receives the digital signal generated from the comparator, and the output terminal outputs the first reference clock to the frequency divider and feedbacks the first reference clock to the second input terminal.

6. The device of claim 1, wherein the signal process device is coupled to an optical information recording/producing apparatus which comprises:
a motor for spinning the optical information recordable medium; and
an optical pick-up head for reading the optical information recordable medium and obtains the set of retrieved signals.

7. The device of claim 6, wherein the optical pick-up head is divided into a left-up area, a right-up area, right-down area, and a left-down area for reading the optical information recordable medium, and the retrieved signals comprises:
a first signal retrieved from the left-up area of the optical pick-up head;
a second signal retrieved from the right-up area of the optical pick-up head;
a third signal retrieved from the right-down area of the optical pick-up head; and
a fourth signal retrieved from the left-down area of the optical pick-up head.

8. The device of claim 1, wherein the RF amplifier synthesizes the retrieved signals to obtain the mix signal according to the following formulae:
the mix signal=(the first signal+the fourth signal)−(the second signal+the third signal).

9. A signal process method for obtaining a wobble signal from a set of retrieved signals, the method comprising:
retrieving the set of retrieved signals reflected from an optical information recordable medium and synthesizing into a mix signal;
performing band-pass filtering on the mix signal based on a target frequency and obtaining a transient-state wobble signal;
performing phase-locked loop and frequency dividing functions on the transient-state wobble signal in a feedback control module for obtaining the target frequency; and
repeatedly amending the target frequency in the feedback control module so as to perform band-pass filtering on the mix signal based on the amended target frequency, and obtaining the desired wobbly signal.

10. The method of claim 9, wherein the target frequency is obtained in the following:
automatically adjusting a gain of the transient-state wobble signal and generating an analog signal with substantially the same peak-to-peak value;
comparing the analog signal with a reference signal to generate a digital signal;
performing phase-locked loop function on the digital signal to generate a first reference clock; and
performing frequency division function on the first reference clock, so as to obtain the target frequency.

11. The method of claim 10, wherein when the transient-state wobble signal is received, the gain is automatically adjusted to avoid wide range of amplitude differences from the transient-state wobble signals in different optical information recordable mediums, so that the amplitudes of the transient-state wobble signals in different optical information recordable medium are kept substantially the same peak-to-peak values.

12. The method of claim 10, wherein before signal comparison, the analog signal is delayed for a period of time for minimizing the noise interference, and after signal comparison, the analog signal is transformed into the digital signal and the reference signal is obtained from the DC level of the set of retrieved signals.

13. The method of claim 10, wherein the phase-locked loop function is performed by an Eight-to-Fourteen Modulation (EFM) phase-locked loop device, and comprises a first input terminal, a second input terminal and an output terminal, and wherein the first input terminal receives the digital signal and the output terminal outputs the first reference clock for further frequency dividing and feedbacks the first reference clock to the second input terminal.

14. The method of claim 9, wherein the method utilizes an optical pick-up head to obtain the retrieved signals reflected from the optical information recordable medium, and the optical pick-up head is divided into a left-up area, a right-up area, right-down area, and a left-down area, and the retrieved signals comprises:
a first signal retrieved from the left-up area of the optical pick-up head;
a second signal retrieved from the right-up area of the optical pick-up head;
a third signal retrieved from the right-down area of the optical pick-up head; and
a fourth signal retrieved from the left-down area of the optical pick-up head.

15. The method of claim 14, wherein the retrieved signals are synthesized into the mix signal according to the following formulae:
the mix signal=(the first signal+the fourth signal)−(the second signal+the third signal).
